(19) United States
(12) Patent Application Publication
(10) Pub. No.: US 2004/0094666 A1
(43) Pub. Date: May 20, 2004

(54) Aircraft emergency system for cabin depressurization

(76) Inventor: John L. Rogitz, San Diego, CA (US)

Correspondence Address: John L. Rogitz, Esq., ROGITZ & ASSOCIATES, Suite 3120, 750 ''B'' Street, San Diego, CA, 92101, US

(21) Appl. No.: 10/295,067

(22) Filed: Nov. 15, 2002

(51) Int. Cl. B64D 11/00; B64D 13/00

(52) U.S. Cl. 244/118.5

(57) ABSTRACT

An aircraft autopilot is automatically engaged to execute an emergency flight profile upon loss of cabin pressure.

### FIELD OF THE INVENTION

The present invention relates generally to aircraft.

### BACKGROUND

Most aircraft cabins are pressurized for the safety and comfort of its occupants. Indeed, without aircraft cabin pressurization, flights at altitudes above a few thousand feet or so could be expected to require the use of oxygen masks, since the oxygen content of the air at altitude is low.

In the event of a sudden cabin depressurization, most commercial airliners have systems that cause oxygen masks to drop down in front of passengers, who can rapidly don the masks to prevent unconsciousness that would otherwise occur. Crew members likewise are availed of breathing aids. The present invention recognizes that an aircraft unfortunately might not have an emergency breathing system or that, even if it does, cabin depressurization can be so rapid or the circumstances of depressurization so severe that people inside the aircraft might be unable to don breathing aids prior to succumbing to unconsciousness. Apart from harmful effects of lack of oxygen to the brain, should the pilots become unconscious, the lives of all on board are placed in jeopardy.

### SUMMARY OF THE INVENTION

A system includes an aircraft autopilot configured to control an aircraft having a cabin, and a cabin pressure sensor generating a signal representative of pressure in the cabin. The autopilot is automatically engaged to execute a predetermined flight profile based on the signal from the pressure sensor. The autopilot may execute the flight profile when cabin pressure falls below a threshold pressure and/or when a rate of decrease of cabin pressure exceeds a threshold rate. The preferred flight profile includes decreasing aircraft altitude.

In another aspect, a computer-implemented method for executing an emergency flight profile in the event of cabin depressurization in an aircraft includes receiving a signal representative of cabin pressure, and determining whether the signal indicates a loss of cabin pressure. Based on the determining act, an autopilot is automatically engaged to control the aircraft.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a schematic diagram of the components of the present invention; and

FIG. 2 is a flow chart of the present logic.

### DETAILED DESCRIPTION OF THE PREFERRED EMBODIMENT

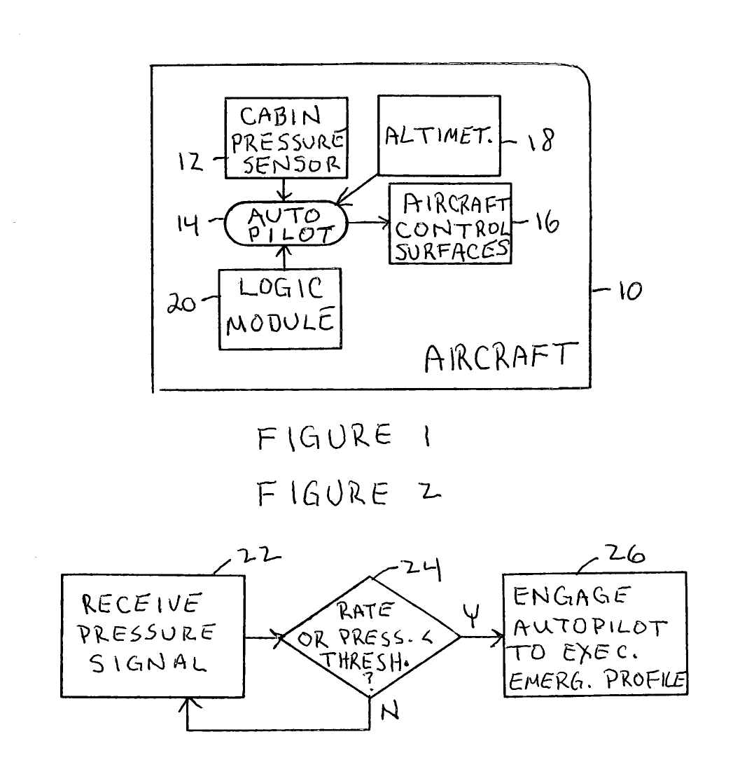

Referring initially to FIG. 1, an aircraft is shown, generally designated 10, that includes a cabin which pilots and passengers occupy. The aircraft 10 includes a cabin pressure sensor 12 for sensing pressure within the cabin and a computer-based autopilot 14 that can be activated to control control surfaces 16, such as rudders, flaps, etc. of the aircraft 10. The autopilot 14 may also receive signals from an altimeter 18 representing the altitude of the aircraft, either above sea level, or above the ground, or both. The autopilot 14 preferably executes a software-implemented, hardware-implemented, or firmware-implemented logic module 20 embodying the logic shown in FIG. 2, although other computers can be provided to execute the logic and cause the autopilot to control the aircraft 10 accordingly.

Commencing at block 22 in FIG. 2, the signal from the pressure sensor 12 is received by the computer executing the logic module 20. If desired, a signal from the altimeter 18 can also be received. At decision diamond 24, a decision is made whether to engage the autopilot to execute an emergency flight profile, based on cabin pressure. In one embodiment, it is determined whether a rate of decrease of cabin pressure exceeds a threshold rate. In another embodiment, it is determined whether cabin pressure falls below a threshold pressure. Both tests can be conducted if desired.

If a threshold has been met and/or crossed (indicating loss of cabin pressure), the logic flows to block 26 to engage the autopilot 14 with the control surfaces 16 to execute an emergency flight profile until such time as a pilot (e.g., a pilot who has not passed out because he or she has had time to don emergency breathing equipment) disengages the autopilot. One example of such a profile is to immediately and rapidly decrease altitude and speed in a descending spiral pattern to an altitude at which ambient atmospheric pressure is sufficient to revive any people in the cabin who may have passed out due to loss of cabin pressure. The aircraft could circle at low altitude until the pilots regain consciousness and disengage the autopilot.

The signal from the altimeter 18 or other sensors can be used to ensure that the flight profile is modified as necessary to avoid flying into mountains. For example, if the altimeter is a radar-based altimeter that measures aircraft altitude above the ground, the final circling altitude can be raised as necessary to provide sufficient clearance between the aircraft and the ground, or the autopilot can drive the aircraft to the nearest sensed location having low elevation, and circle there at low altitude until a revived pilot regains consciousness and disengages the autopilot.

In conjunction with executing the emergency flight profile at block 26, an emergency signal can be broadcast from the aircraft indicating loss of cabin pressure.

While the particular AIRCRAFT EMERGENCY SYSTEM FOR CABIN DEPRESSURIZATION as herein shown and described in detail is fully capable of attaining the above-described objects of the invention, it is to be understood that it is the presently preferred embodiment of the present invention and is thus representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more”. All structural and functional equivalents to the elements of the above-described preferred embodiment that are known or later come to be known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. §112, sixth paragraph, unless the element is expressly recited using the phrase “means for” or, in the case of a method claim, the element is recited as a “step” instead of an “act”. Absent express definitions herein, claim terms are to be given all ordinary and accustomed meanings that are not irreconcilable with the present specification and file history.

What is claimed is:

1. A system comprising:
at least one aircraft autopilot configured to control an aircraft having a cabin; and
at least one cabin pressure sensor generating a signal representative of pressure in the cabin, the autopilot being automatically engaged to execute a predetermined flight profile based on the signal from the pressure sensor.

2. The system of claim 1, comprising the aircraft.

3. The system of claim 1, wherein the autopilot executes the flight profile when cabin pressure falls below a threshold pressure.

4. The system of claim 1, wherein the autopilot executes the flight profile when a rate of decrease of cabin pressure exceeds a threshold rate.

5. The system of claim 1, wherein the flight profile includes decreasing aircraft altitude.

6. A computer-implemented method for executing an emergency flight profile in the event of cabin depressurization in an aircraft, comprising:
receiving a signal representative of cabin pressure;
determining whether the signal indicates a loss of cabin pressure; and
based on the determining act, automatically engaging an autopilot to control the aircraft.

7. The method of claim 6, wherein the autopilot executes the flight profile when cabin pressure falls below a threshold pressure.

8. The method of claim 6, wherein the autopilot executes the flight profile when a rate of decrease of cabin pressure exceeds a threshold rate.

9. The method of claim 6, wherein the flight profile includes decreasing aircraft altitude.

10. A system for executing an emergency flight profile in the event of cabin depressurization in an aircraft, comprising:
means for generating a signal representative of cabin pressure;
means for determining whether the signal indicates a loss of cabin pressure; and
means for, based on the determining act, automatically engaging an autopilot to control the aircraft.

11. The system of claim 10, wherein the autopilot executes the flight profile when cabin pressure falls below a threshold pressure.

12. The system of claim 10, wherein the autopilot executes the flight profile when a rate of decrease of cabin pressure exceeds a threshold rate.

13. The system of claim 10, wherein the flight profile includes decreasing aircraft altitude.
